(19) United States
(12) Patent Application Publication
(10) Pub. No.: US 2026/0003034 A1
(43) Pub. Date: Jan. 1, 2026

(54) WIFI RADAR COMMUNICATION CIRCUIT AND INTERFERENCE DETECTION METHOD

(71) Applicant: Realtek Semiconductor Corporation, Hsinchu (TW)

(72) Inventors: Wen-Yung LEE, Hsinchu (TW); Cho-Han YU, Hsinchu (TW); Shau-Yu CHENG, Hsinchu (TW)

(21) Appl. No.: 19/250,093

(22) Filed: Jun. 26, 2025

Related U.S. Application Data
(60) Provisional application No. 63/665,256, filed on Jun. 28, 2024.

(30) Foreign Application Priority Data
May 19, 2025 (TW) 114118683

(51) Int. Cl. G01S 7/35; G01S 7/40

(52) U.S. Cl. CPC G01S 7/352; G01S 7/40

(57) ABSTRACT

A WiFi radar communication circuit includes a radio frequency front-end circuit, an analog-to-digital converter, and a digital signal processor. The radio frequency front-end circuit is coupled to a transmitting antenna and a receiving antenna for transmitting a radar frame and receiving reflected echoes. The analog-to-digital converter is configured to convert the reflected echoes into radar echo digital signals. The digital signal processor is configured to operate an interference detector. The interference detector is configured to determine whether each reflected chirp among the reflected chirps is subject to interference based on a cumulative power difference between adjacent reflected chirps. The interference detector is further configured to determine whether the radar frame is subject to interference based on a statistical result of whether the reflected chirps are subject to interference. Accordingly, interference detection results for the radar frame and the reflected chirps are generated.

### RELATED APPLICATIONS

This application claims the priority benefit of U.S. Provisional Application Ser. No. 63/665,256, filed Jun. 28, 2024, and Taiwan Application Serial Number 114118683, filed May 19, 2025, which are herein incorporated by reference.

### BACKGROUND

### Field of Invention

The disclosure relates to a WiFi radar communication circuit and an interference detection method, and more particularly, to a detection method for determining whether a radar frame and individual reflected chirps within the radar frame are subject to interference.

### Description of Related Art

WiFi radar technology employs the reflective, scattering, and diffractive properties of wireless signals for sensing, similar to conventional radar. Unlike traditional radar systems, WiFi radar eliminates the need for additional radar transmission hardware by utilizing existing WiFi transceiver circuitry. This allows for the transmission of radar signals to detect environmental changes and target motion primarily using the original WiFi hardware. However, these transmitted radar frames are vulnerable to environmental interference (such as competition from other WiFi signals, interference from Bluetooth communications, and multipath effects). Therefore, how to determine whether a radar frame is subject to signal interference and accordingly generate an interference detection result is one of the challenges in WiFi radar technology.

### SUMMARY

An embodiment of the disclosure provides a WiFi radar communication circuit, which includes a radio frequency front-end circuit, an analog-to-digital converter, and a digital signal processor. The radio frequency front-end circuit is coupled to a transmitting antenna and a receiving antenna. The transmitting antenna is configured to transmit a radar frame, and the receiving antenna is configured to receive a reflection echo corresponding to the radar frame. The reflection echo includes reflected chirps. The analog-to-digital converter is coupled to the radio frequency front-end circuit and is configured to convert the reflection echo into a radar echo digital signal. The radar echo digital signal includes digital signals of the plurality of reflected chirps. The digital signal processor is coupled to the analog-to-digital converter, and the digital signal processor is configured to operate an interference detector. The interference detector is configured to determine whether each of the reflected chirps is subject to interference based on a cumulative power difference between adjacent reflected chirps among the reflected chirps, and to determine whether the radar frame is subject to interference based on a statistical result of whether the reflected chirps are subject to interference, thereby generating interference detection results for the radar frame and the plurality of reflected chirps.

Another embodiment of the disclosure provides an interference detection method, includes the following steps: transmitting a radar frame; receiving a reflection echo corresponding to the radar frame, wherein the reflection echo comprises a plurality of reflected chirps; calculating a cumulative power difference between every two adjacent reflected chirps among the plurality of reflected chirps, and determining whether each of the plurality of reflected chirps is subject to interference; and performing a statistical analysis of whether each of the plurality of reflected chirps is subject to interference, and determining whether the radar frame is subject to interference.

It is to be understood that both the foregoing general description and the following detailed description are by examples, and are intended to provide further explanation of the invention as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram illustrating a WiFi radar communication circuit according to some embodiments of the present disclosure.

FIG. 2 is a schematic diagram illustrating interference packets on surrounding frequency bands encountered when the WiFi radar communication circuit transceives radar frames via a radar transceiving band, according to some embodiments of the present disclosure.

FIG. 3 is a functional block diagram of a guard interval remover and an interference detector operated by the digital signal processor of FIG. 1.

FIG. 4 is a flowchart illustrating an interference detection method according to an embodiment of the present disclosure.

FIG. 5 is a flowchart illustrating more detailed steps of the interference detection method in some embodiments.

### DETAILED DESCRIPTION

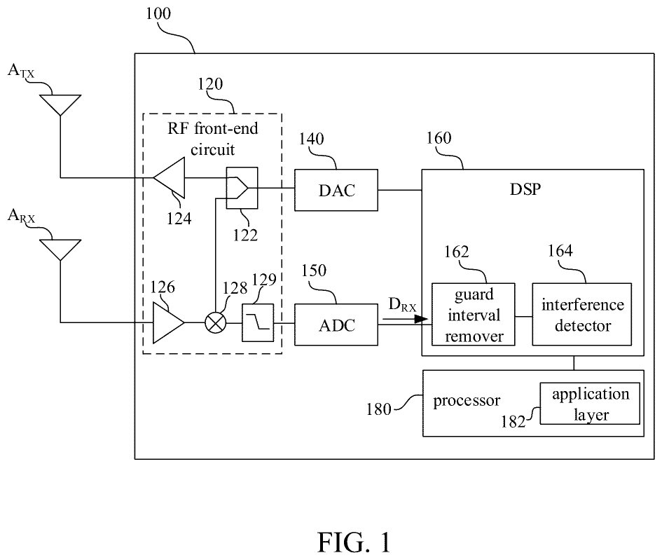

Reference is made to FIG. 1, which is a schematic diagram illustrating a WiFi radar communication circuit 100 according to some embodiments of the present disclosure. In an embodiment, the WiFi radar communication circuit 100 has hardware components similar to components of a WiFi transceiver circuit. Furthermore, the WiFi radar communication circuit 100 can utilize the WiFi transceiver circuit to implement scanning signals as required by an antenna. For example, the WiFi radar communication circuit 100 can generate Orthogonal Frequency-Division Multiplexing (OFDM) signals and use the OFDM signals to simulate the generation of Frequency Modulated Continuous Wave (FMCW) radar scanning signals. That is to say, in addition to transceiving WiFi communication packets, the WiFi radar communication circuit 100 can also transmit radar frames and receive radar reflection echoes.

The WiFi radar communication circuit 100 can be applied in scenarios such as human presence sensing and motion detection (e.g., in smart homes, detecting if someone is in the house via Wi-Fi signals), health monitoring, gesture control (e.g., contactless control, operating smart devices with gestures), or smart surveillance systems (e.g., for home security, detecting abnormal movements or intruders).

In the embodiment shown in FIG. 1, the WiFi radar communication circuit 100 includes a radio frequency front-end (RF front-end) circuit 120, a digital-to-analog converter (DAC) 140, an analog-to-digital converter (ADC) 150, a digital signal processor (DSP) 160, and a processor 180. It should be particularly noted that various hardware structures can be used to implement the WiFi radar communication circuit 100. FIG. 1 illustrates one such implemented circuit architecture, but the present disclosure is not limited to the hardware architecture shown in FIG. 1.

The radio frequency front-end circuit 120 is coupled to a transmitting antenna A_{TX} and a receiving antenna A_{RX}. In this embodiment, the radio frequency front-end circuit 120 may include a signal coupler 122, a power amplifier 124, a low noise amplifier (LNA) 126, a mixer 128, and a filter 129. The radio frequency front-end circuit 120 is configured to control the transmitting antenna A_{TX} and the receiving antenna A_{RX} to operate in a radar transceiving band or a WiFi communication band. The power amplifier 124 is configured to provide gain for signals transmitted by the antenna. The low noise amplifier 126 is configured to enhance signals received by the antenna and improve sensitivity. The mixer 128 is configured to perform frequency conversion on the received antenna signals. The filter 129 is configured to regulate or select the frequency band of signals to pass through.

The digital-to-analog converter 140 is coupled between the digital signal processor 160 and the radio frequency front-end circuit 120 and is configured to convert digital signals provided by the digital signal processor 160 into analog signals. The analog-to-digital converter 150 is coupled between the radio frequency front-end circuit 120 and the digital signal processor 160.

For example, the WiFi communication band can cover wireless communication bands such as those around 2.4 GHz, 5 GHz, and 6 GHz; the radar transceiving band can cover, for example, the wireless communication band from 5.725 GHz to 5.875 GHz. In some embodiments, the radar transceiving band used by the WiFi radar communication circuit 100 may have some degree of overlap with general WiFi communication bands. Therefore, when the WiFi radar communication circuit 100 transceives radar frames, it may be subject to interference from other WiFi signal sources or the surrounding environment. Furthermore, besides being affected by WiFi communication packets, the radar frames transceived by the WiFi radar communication circuit 100 may also be affected by other surrounding wireless communication packets (e.g., Bluetooth communication packets or Zigbee communication packets).

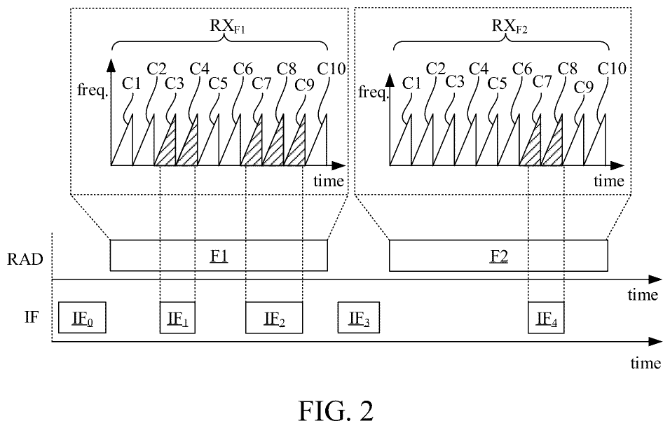

Reference is also made to FIG. 2, which is a schematic diagram illustrating interference packets IF₀˜IF₄ on surrounding frequency bands IF when the WiFi radar communication circuit 100 transceives radar frames F₁, F₂ via a radar transceiving band RAD, according to some embodiments of the present disclosure. The interference packets IF₀˜IF₄ can be one of WiFi communication packets, Bluetooth communication packets, or Zigbee communication packets.

As shown in FIG. 2, when the WiFi radar communication circuit 100 performs a radar transceiving function, the WiFi radar communication circuit 100 transmits a radar frame F₁ via the transmitting antenna A_{TX}. The receiving antenna A_{RX} is configured to receive a reflection echo RX_{F1} corresponding to the radar frame F₁. The radar frame F₁ is a Frequency Modulated Continuous Wave (FMCW) radar frame, and each FMCW radar frame includes multiple linear frequency sweep signals, for example, chirp signals. The reflection echo RX_{F1} includes ten reflected chirps C1˜C10.

In the embodiment shown in FIG. 2, each of the reflection echo RX_{F1} and the reflection echo RX_{F2}, corresponding to radar frames F₁ and F₂ respectively, includes ten reflected chirps C1C10. However, the present disclosure is not limited to this. In practical applications, the number of reflected chirps per frame can be set according to practical requirements.

Hereinafter, for brevity of explanation, the signal processing of the reflection echo RX_{F1} will be used as an example. Similar signal processing can also be applied to the reflection echo RX_{F2}.

The analog-to-digital converter 150 is configured to convert the reflection echo RX_{F1} into a radar echo digital signal D_{RX}. The radar echo digital signal D_{RX} includes digital signals of the reflected chirps C1˜C10.

The digital signal processor 160 is configured to perform signal processing on the radar echo digital signal D_{RX} (e.g., filtering, signal extraction, interference detection, etc.). In this embodiment, the digital signal processor 160 is configured to operate a guard interval remover 162 and an interference detector 164. The guard interval remover 162 is configured to remove guard intervals, which do not carry valid data, from the reflection echo RX_{F1} and the reflection echo RX_{F2} in order to extract valid signal content.

In an embodiment, the interference detector 164 is configured to determine whether each of the reflected chirps C1˜C10 corresponding to the radar frame F₁ is subject to interference, based on a cumulative power difference between adjacent reflected chirps among these reflected chirps C1˜C10. Furthermore, the interference detector 164 can determine whether this radar frame F₁ is subject to interference based on a statistical result of whether the reflected chirps C1˜C10 are subject to interference, thereby generating interference detection results for the radar frame F₁ and the reflected chirps C1˜C10. Similarly, the interference detector 164 can also perform similar interference detection based on the reflected chirps C1˜C10 corresponding to the radar frame F₂. The operational details of the aforementioned interference detector 164 will be further described in subsequent paragraphs.

The processor 180 can be configured to execute software instructions (e.g., algorithms, control methods) of an application layer 182. The interference detection results generated by the interference detector 164 can be provided to the application layer 182 of the processor 180 as a reference for subsequent signal processing (e.g., discarding radar frames subject to excessive interference, or masking portions of reflected chirps within a radar frame that are subject to interference).

In an embodiment, the guard interval remover 162 and the interference detector 164 can be implemented by software instructions or firmware executed on the digital signal processor 160. In another embodiment, the guard interval remover 162 and the interference detector 164 can also be implemented by a field-programmable gate array (FPGA) circuit.

The processor 180 can be implemented by a central processing unit (CPU), a microcontroller (MCU), an application-specific integrated circuit (ASIC), or a field-programmable gate array (FPGA).

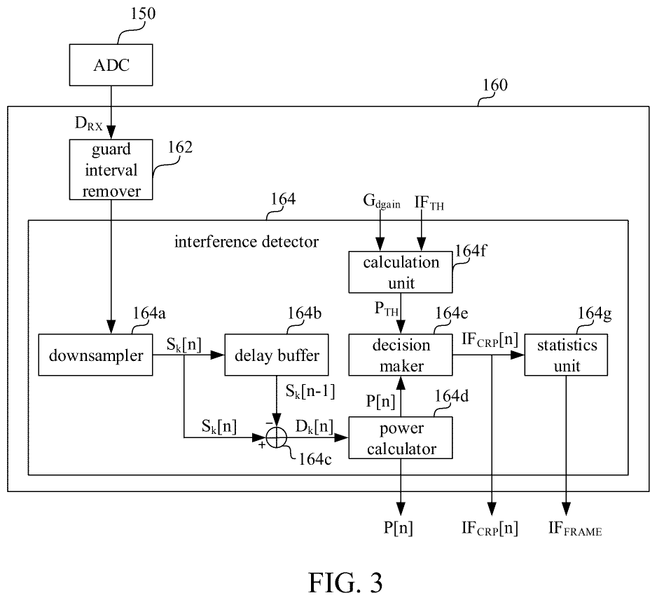

Reference is also made to FIG. 3, which is a functional block diagram of the guard interval remover 162 and the interference detector 164 operated by the digital signal processor 160 of FIG. 1.

As shown in FIG. 3, the interference detector 164 includes a downsampler 164a, a delay buffer 164b, an adder-subtractor 164c, a power calculator 164d, a decision maker 164e, a calculation unit 164f, and a statistics unit 164g. The aforementioned components can be implemented by software instructions or firmware, or by a field-programmable gate array circuit.

The downsampler 164a is coupled to the guard interval remover 162 and through it to the analog-to-digital converter 150. The downsampler 164a is configured to downsample the digital signals of the reflected chirps C1C10 to obtain a plurality of sample values Sₖ [n] corresponding to each reflected chirp. Each sample value represents the voltage amplitude or current amplitude of a certain reflected chirp at a specific sampling time point. Here, “n” represents the sample value of the n-th reflected chirp, and in this embodiment, “n” is a positive integer from 1 to 10 (corresponding to reflected chirps C1C10). “k” represents the k-th sample point. Assuming each of the reflected chirps C1˜C10 respectively employs 16 sample points, then “k” is a positive integer from 1 to 16. For example, sample values S₁[1]˜S₁₆[1] are the 1st to 16th sample points of reflected chirp C1, and sample values S₁[2]˜S₁₆[2] are the 1st to 16th sample points of reflected chirp C2, and so forth.

In an embodiment, the downsampler 164a can use a Fast Fourier Transform (FFT) operation or a Discrete Fourier Transform (DFT) operation to downsample the digital signals of each reflected chirp C1˜C10, thereby generating a plurality of sample values Sₖ[n] for each reflected chirp.

The delay buffer 164b is configured to buffer K sample values of each reflected chirp C1˜C10. In an embodiment, the delay buffer 164b is configured to provide a delay equal to the duration of one reflected chirp period.

In other words, when the downsampler 164a samples the n-th reflected chirp to generate sample values Sₖ[n] and provides them to the adder-subtractor 164c, the delay buffer 164b can provide the sample values Sₖ[n−1] of the preceding reflected chirp (i.e., the (n−1)-th reflected chirp) to the adder-subtractor 164c.

The adder-subtractor 164c is configured to subtract, respectively, the 16 sample values Sₖ[n−1] of the adjacent (n−1)-th reflected chirp from the 16 sample values Sₖ[n] of the n-th reflected chirp to obtain 16 sample differences Dₖ[n]. Here, the sample difference Dk[n]=Sₖ[n]−Sₖ[n−1]. In other words, the sample difference Dₖ[n] represents the difference in voltage amplitude or current amplitude between corresponding sample points of two adjacent reflected chirps.

The power calculator 164d is coupled to the adder-subtractor 164c. The power calculator 164d is configured to calculate the cumulative power difference p[n] between the n-th reflected chirp and the (n−1)-th reflected chirp based on the 16 sample differences Dₖ[n]. In an embodiment, the cumulative power difference p[n] is calculated by:

$$p [ n ] = {\sum }_{k = 1}^{16} \frac{{\vert {D}_{k} [ n ] \vert}^{2}}{32} = {\sum }_{k = 1}^{16} \frac{{\vert {S}_{k} [ n ] - {S}_{k} [ n - 1 ] \vert}^{2}}{32}$$

In the present disclosure, the sample value Sₖ[n] includes the reflected signal component xₖ[n] of the n-th reflected chirp and the noise signal component wₖ[n]; the sample value Sₖ[n−1] includes the reflected signal component xₖ[n−1] of the (n−1)-th reflected chirp and the noise signal component wₖ[n−1]. Generally, in a Frequency Modulated Continuous Wave (FMCW) radar frame, the waveform of each transmitted chirp is consistent. Therefore, when the sample values Sₖ[n] and Sₖ[n−1] of two adjacent reflected chirps are subtracted, the reflected signal components xₖ[n] and wₖ[n−1] will substantially cancel each other out, leaving only the noise signal components, i.e., wₖ[n]−wₖ[n−1].

Furthermore, assuming that the noise signals wₖ[n] and wₖ[n−1] both exhibit a random normal distribution, for example, being Independent and Identically Distributed (IID), then in a situation where two adjacent reflected chirps both encounter noise interference, the noise signal components wₖ[n]−wₖ[n−1] are independently distributed and will not cancel each other out.

Therefore, the cumulative power difference p[n] can reflect the cumulative noise power of the n-th reflected chirp relative to the (n−1)-th reflected chirp. When the n-th reflected chirp encounters greater noise interference, the cumulative power difference p[n] calculated by the power calculator 164d will increase accordingly. Conversely, when the n-th reflected chirp encounters smaller noise interference, the cumulative power difference p[n] calculated by the power calculator 164d will decrease accordingly.

The power calculator 164d can generate the cumulative power difference p[n] of the n-th reflected chirp (relative to the preceding reflected chirp), which can represent the level (high or low) of noise interference encountered by the n-th reflected chirp.

The decision maker 164e is configured to compare the cumulative power difference p[n] of the n-th reflected chirp with a power threshold value P_{TH}, thereby determining whether the n-th reflected chirp is subject to interference, and consequently generating a contamination flag IF_{CRP}[n] for the n-th reflected chirp. For example, if the cumulative power difference p[n]≥P_{TH}, the contamination flag IF_{CRP}[n] for the n-th reflected chirp is set to 1; if the cumulative power difference p[n]<P_{TH}, the contamination flag IF_{CRP}[n] is set to 0. Thereby, the decision maker 164e can sequentially determine whether each of the reflected chirps C2˜C10 in the radar frame F₁ is subject to interference.

In an embodiment, the power threshold value P_{TH} is calculated by the calculation unit 164f based on a linear gain value G_{dgain} in the data path and an interference decision threshold parameter IF_{TH}. For example, the power threshold value P_{TH} can be the product of the linear gain value G_{dgain} and the interference decision threshold parameter IF_{TH}. The linear gain value G_{dgain} can be provided by a digital automatic gain control (DAGC) circuit. The interference decision threshold parameter IF_{TH} can be dynamically set to adjust the power threshold value P_{TH}.

In some embodiments, the lower the power threshold value P_{TH} is set, the more easily a reflected chirp is determined to be subject to interference. The higher the power threshold value P_{TH} is set, the more likely a reflected chirp is determined not to be subject to interference. The setting of the power threshold value P_{TH} can be dynamically adjusted according to actual requirements.

In the embodiment of FIG. 2, the radar frame F₁ corresponds to reflected chirps C1˜C10. Among them, reflected chirps C3 and C4 encounter interference packet IF₁, and reflected chirps C7, C8, and C9 encounter interference packet IF₂.

In this example, for reflected chirp C2 (relative to reflected chirp C1), the cumulative power difference p[2] calculated by the power calculator 164d is relatively low, and the decision maker 164e can determine that reflected chirp C2 has not encountered interference.

For reflected chirp C3 (relative to reflected chirp C2), the cumulative power difference p[3] calculated by the power calculator 164d is relatively high, and it can be determined that reflected chirp C3 has encountered interference.

Similarly, for reflected chirp C4 (relative to reflected chirp C3), because the noise signal components are independently distributed and do not cancel each other out, the cumulative power difference p[4] calculated by the power calculator 164d is relatively high, and it can be determined that reflected chirp C4 has encountered interference.

By analogy, the power calculator 164d and the decision maker 164e can detect that reflected chirps C3, C4, C7, C8, and C9 within radar frame F₁ have encountered interference. The corresponding five contamination flags IF_{CRP}[n] (where n=3, 4, 7, 8, 9) can be set to 1, and the remaining contamination flags IF_{CRP}[n] can be set to 0.

Next, the statistics unit 164g can, based on the multiple contamination flags IF_{CRP}[n], ascertain how many reflected chirps in radar frame F₁ are subject to interference (total number of interfered reflected chirps), and generate a frame contamination flag IF_{FRAME} for radar frame F₁. For example, when the total number of interfered reflected chirps exceeds a predetermined proportion (e.g., 40%), the statistics unit 164g determines that this radar frame is contaminated. Taking radar frame F₁ as an example, five reflected chirps in radar frame F₁ are subject to interference (exceeding 4 out of 10, if the total is 10). The statistics unit 164g determines that radar frame F₁ is severely interfered and thus sets the frame contamination flag IF_{FRAME} for radar frame F₁ to 1. At this point, the statistics unit 164g can decide to discard the sampling result of the reflection echo RX_{F1} of radar frame F₁, and not report the sampling result to the application layer 182 of the processor 180.

On the other hand, the power calculator 164d and the decision maker 164e can detect that two reflected chirps C7 and C8 in radar frame F₂ have encountered interference (the proportion of interfered reflected chirps is below 40%). The statistics unit 164g determines that radar frame F₂ is not severely interfered and thus sets the frame contamination flag IF_{FRAME} for radar frame F2 to 0.

At this time, the statistics unit 164g can decide to report the sampling result of the reflection echo RX_{F2} of radar frame F₂ to the application layer 182 of the processor 180. In some embodiments, the statistics unit 164g can also filter out the sample values of the reflected chirps C7 and C8 determined to be interfered, based on the contamination flags IF_{CRP}[n] of the reflected chirps, and then report the sample values of the other uninterfered reflected chirps C1˜C6 and C9˜C10 to the application layer 182 of the processor 180.

In an embodiment, the statistics unit 164g can, for each radar frame F₁ and F₂ respectively, compile statistical information such as the total number of interfered reflected chirps within a single frame, a distribution map of interfered reflected chirps within a single frame, and the frame contamination flag IF_{FRAME} for a single frame. This statistical information can then be provided to the application layer 182 of the processor 180. When the application layer 182 of the processor 180 processes radar frames F₁ and F₂, it can clearly ascertain the severity of interference for each radar frame F₁ and F₂, and also identify which reflected chirps are more reliable.

In summary, the interference detector 164 can generate interference detection results for radar frames F₁ and F₂ (e.g., frame contamination flags IF_{FRAME} for radar frames F₁ and F₂, total number and distribution map of interfered reflected chirps) and interference detection results for each of the reflected chirps C1˜C10 (e.g., including cumulative power differences p[n] for reflected chirps C1˜C10, contamination flags IF_{CRP}[n] for reflected chirps C1˜C10).

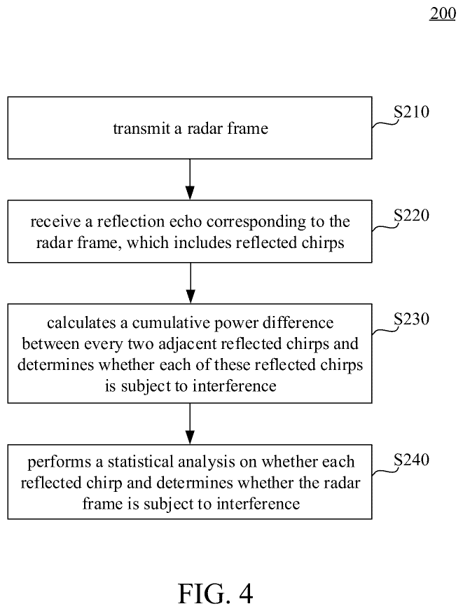

Reference is also made to FIG. 4, which is a flowchart illustrating an interference detection method 200 according to an embodiment of the present disclosure. The interference detection method 200 can be executed by the WiFi radar communication circuit 100 shown in FIG. 1 and FIG. 3.

As shown in FIG. 1, FIG. 2, FIG. 3, and FIG. 4, first, step S210 is executed to transmit a radar frame F1. Next, step S220 is executed to receive a reflection echo corresponding to the radar frame F₁, which includes a plurality of reflected chirps C1˜C10.

Next, in step S230, the interference detector 164 calculates a cumulative power difference (e.g., the cumulative power difference p[n] of the n-th reflected chirp) between every two adjacent reflected chirps among the reflected chirps C1˜C10, and determines whether each of these reflected chirps is subject to interference.

Next, in step S240, the interference detector 164 performs a statistical analysis on whether each reflected chirp in the radar frame F₁ is subject to interference, and determines whether the radar frame F₁ is subject to interference.

Similarly, the same steps S210˜S240 can also be repeatedly executed for another radar frame F₂.

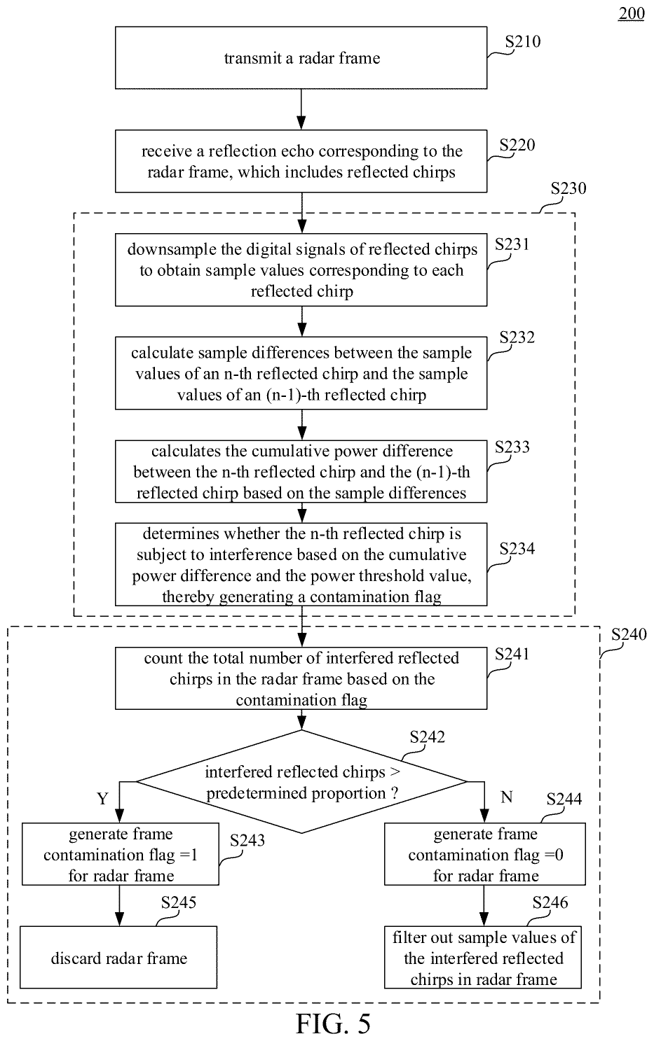

Reference is also made to FIG. 5, which is a flowchart illustrating, in some embodiments, more detailed steps included in steps S230 and S240 of the interference detection method 200.

In the embodiment shown in FIG. 5, the aforementioned step S230 further includes steps S231˜S234. In step S231, the downsampler 164a is configured to downsample the digital signals of reflected chirps C1˜C10 to obtain a plurality of sample values Sₖ[n] corresponding to each reflected chirp C1˜C10, in which “n” represents the n-th reflected chirp, and “k” represents the k-th sample point.

In step S232, the adder-subtractor 164c is configured to calculate a plurality of sample differences Dₖ[n] between the sample values Sₖ[n] of an n-th reflected chirp and the sample values Sₖ[n−1] of an (n−1)-th reflected chirp, in which “n” is a positive integer.

In step S233, the power calculator 164d calculates the cumulative power difference p[n] between the n-th reflected chirp and the (n−1)-th reflected chirp based on the sample differences Dₖ[n].

In step S234, the decision maker 164e determines whether the n-th reflected chirp is subject to interference based on the cumulative power difference p[n] and the power threshold value P_{TH}, thereby generating a contamination flag IF_{CRP}[n] for the n-th reflected chirp.

Next, in the embodiment shown in FIG. 5, the aforementioned step S240 further comprises steps S241˜S246.

In step S241, the statistics unit 164g counts the total number of interfered reflected chirps in the radar frame F₁ based on the contamination flag IF_{CRP}[n] of each reflected chirp.

Next, step S242 is executed to determine whether the total number

of interfered reflected chirps in the radar frame F₁ is greater than a predetermined proportion (e.g., 40%).

According to the example in FIG. 2, the total number of interfered reflected chirps in radar frame F₁ is five. It is determined in step S242 that this number is greater than the predetermined proportion.

Next, step S243 is executed to generate a frame contamination flag IF_{FRAME} for radar frame F₁ based on the total number of interfered reflected chirps; in this case, the frame contamination flag IF_{FRAME} will be set to 1. Then, step S245 is executed to discard the radar frame F₁, which has been determined to be severely contaminated. In some embodiments, the discarded radar frame F₁ is not reported to the application layer 182.

On the other hand, according to the example in FIG. 2, the total number of interfered reflected chirps in radar frame F₂ is two. It is determined in step S242 that this number is less than the predetermined proportion. At this time, step S244 is executed to generate a frame contamination flag IF_{FRAME} for radar frame F₂ based on the total number of interfered reflected chirps; in this case, the frame contamination flag IF_{FRAME} is set to 0, indicating that radar frame F2 is not contaminated or the degree of contamination is relatively low. Next, step S246 is executed to filter out the sample values of the interfered reflected chirps in radar frame F₂. In some embodiments, the sample values corresponding to the reflected chirps C7 and C8 (determined to be interfered) in radar frame F₂ are filtered out, and the remaining reflected chirps in radar frame F₂ can be reported to the application layer 182.

Thereby, the interference detector 164, based on an analysis of power fluctuations of each reflected chirp in the received radar signal, determines whether a reflected chirp is subject to interference by comparing with a threshold value, and further determines the interference level of the entire radar frame by statistically analyzing the number of interfered reflected chirps. This can help the WiFi radar communication circuit 100 identify valid radar measurement results and discard or process severely interfered data, thereby improving radar performance in co-channel environments.

What is claimed is:

1. A WiFi radar communication circuit, comprising:
a radio frequency front-end circuit, coupled to a transmitting antenna and a receiving antenna, the transmitting antenna being configured to transmit a radar frame, the receiving antenna being configured to receive a reflection echo corresponding to the radar frame, the reflection echo comprising a plurality of reflected chirps;
an analog-to-digital converter, coupled to the radio frequency front-end circuit, configured to convert the reflection echo into a radar echo digital signal, the radar echo digital signal comprising a digital signal of the plurality of reflected chirps; and
a digital signal processor, coupled to the analog-to-digital converter, the digital signal processor being configured to operate an interference detector, the interference detector being configured to determine whether each of the plurality of reflected chirps is subject to interference based on a cumulative power difference between adjacent ones of the plurality of reflected chirps, and configured to determine whether the radar frame is subject to interference based on a statistical result of whether the plurality of reflected chirps are subject to interference, thereby generating an interference detection result for the radar frame and the plurality of reflected chirps.

2. The WiFi radar communication circuit of claim 1, wherein the interference detector comprises:
a downsampler, coupled to the analog-to-digital converter, configured to downsample the digital signal of the plurality of reflected chirps to obtain a plurality of sample values corresponding to each of the plurality of reflected chirps;
a delay buffer, configured to buffer the plurality of sample values of each of the plurality of reflected chirps;
an adder-subtractor, coupled to the downsampler and the delay buffer, the adder-subtractor being configured to calculate a plurality of sample differences between an n-th reflected chirp of the plurality of reflected chirps and an (n−1)-th reflected chirp of the plurality of reflected chirps, wherein n is a positive integer;
a power calculator, coupled to the adder-subtractor, configured to calculate the cumulative power difference between the n-th reflected chirp and the (n−1)-th reflected chirp based on the plurality of sample differences; and
a decision maker, coupled to the power calculator, configured to determine whether the n-th reflected chirp is subject to interference based on the cumulative power difference and a power threshold value, thereby generating a contamination flag for the n-th reflected chirp.

3. The WiFi radar communication circuit of claim 2, wherein the interference detector further comprises:
a statistics unit, coupled to the decision maker, configured to count a total number of reflected chirps subject to interference in the radar frame based on the contamination flag of the n-th reflected chirp, thereby generating a frame contamination flag for the radar frame.

4. The WiFi radar communication circuit of claim 3, wherein when the statistics unit determines that the total number of reflected chirps subject to interference in the radar frame is greater than a predetermined proportion, the reflection echo of the radar frame is discarded.

5. The WiFi radar communication circuit of claim 3, wherein when the statistics unit determines that the total number of reflected chirps subject to interference in the radar frame is less than a predetermined proportion, at least one sample value corresponding to at least one reflected chirp determined to be subject to interference in the radar frame is filtered out.

6. The WiFi radar communication circuit of claim 2, wherein the downsampler performs the downsampling on the digital signal of the plurality of reflected chirps by using a Fast Fourier Transform operation or a Discrete Fourier Transform operation.

7. The WiFi radar communication circuit of claim 2, wherein the interference detector further comprises:
a calculation unit, coupled to the decision maker, configured to calculate the power threshold value based on a linear gain value and an interference decision threshold parameter.

8. The WiFi radar communication circuit of claim 1, wherein the digital signal processor is further configured to operate a guard interval remover, and the guard interval remover is configured to remove a guard interval from the radar echo digital signal.

9. The WiFi radar communication circuit of claim 1, wherein the radar frame is a Frequency Modulated Continuous Wave (FMCW) radar frame.

10. An interference detection method, comprising:
transmitting a radar frame;
receiving a reflection echo corresponding to the radar frame, the reflection echo comprising a plurality of reflected chirps;
calculating a cumulative power difference between every two adjacent ones of the plurality of reflected chirps, and determining whether each of the plurality of reflected chirps is subject to interference; and
performing a statistical analysis of whether each of the plurality of reflected chirps is subject to interference, and determining whether the radar frame is subject to interference.

11. The interference detection method of claim 10, wherein the step of calculating the cumulative power difference between every two adjacent ones of the plurality of reflected chirps and determining whether each of the plurality of reflected chirps is subject to interference comprises:
downsampling a digital signal of the plurality of reflected chirps to obtain a plurality of sample values corresponding to each of the plurality of reflected chirps;
calculating a plurality of sample differences between a plurality of first sample values of an n-th reflected chirp of the plurality of reflected chirps and a plurality of second sample values of an (n−1)-th reflected chirp of the plurality of reflected chirps, wherein n is a positive integer;
calculating the cumulative power difference between the n-th reflected chirp and the (n−1)-th reflected chirp based on the plurality of sample differences; and
determining whether the n-th reflected chirp is subject to interference based on the cumulative power difference and a power threshold value, thereby generating a contamination flag for the n-th reflected chirp.

12. The interference detection method of claim 11, wherein the step of performing the statistical analysis of whether each of the plurality of reflected chirps is subject to interference and determining whether the radar frame is subject to interference comprises:
counting a total number of reflected chirps subject to interference in the radar frame based on the contamination flag of the n-th reflected chirp; and
generating a frame contamination flag for the radar frame based on the total number of reflected chirps subject to interference.

13. The interference detection method of claim 12, wherein the step of performing the statistical analysis of whether each of the plurality of reflected chirps is subject to interference and determining whether the radar frame is subject to interference further comprises:
when the total number of reflected chirps subject to interference in the radar frame is greater than a predetermined proportion, discarding the reflection echo of the radar frame.

14. The interference detection method of claim 12, wherein the step of performing the statistical analysis of whether each of the plurality of reflected chirps is subject to interference and determining whether the radar frame is subject to interference further comprises:
when the total number of reflected chirps subject to interference in the radar frame is less than a predetermined proportion, filtering out at least one sample value corresponding to at least one reflected chirp determined to be subject to interference in the radar frame.

15. The interference detection method of claim 11, wherein the downsampling is performed on the digital signal of the plurality of reflected chirps by using a Fast Fourier Transform operation or a Discrete Fourier Transform operation.

16. The interference detection method of claim 11, wherein the power threshold value is calculated based on a linear gain value and an interference decision threshold parameter.

17. The interference detection method of claim 11, further comprising removing a guard interval from a radar echo digital signal.

18. The interference detection method of claim 11, wherein the radar frame is a Frequency Modulated Continuous Wave (FMCW) radar frame.
